(19) United States
(12) Patent Application Publication
(10) Pub. No.: US 2012/0037321 A1
(43) Pub. Date: Feb. 16, 2012

(54) Mounting rod for a roll-up blind

(76) Inventor: Dung Viet Pham, Mississauga (CA)

(21) Appl. No.: 12/806,510

(22) Filed: Aug. 16, 2010

(51) Int. Cl. E06B 9/44; A47H 1/022

(52) U.S. Cl. 160/121.1; 160/120

(57) ABSTRACT

A head rod is for mounting a roll-up window blind in a window frame. The head rod has two tubular rods slidably mounted with one another. An elongated is formed throughout the entire bottom of the first tubular rod. A first window blind panel is secured to the first tubular rod and a second window blind is secured to the second tubular rod and extending downward through the bottom slot formed in the first tubular rod. A fixed length inner rod or a telescopic inner rod is slidably mounted in the first and second tubular rods. The telescopic inner rod can be adjusted in length for mounting the blind in windows of various inner widths.

### BACKGROUND OF THE INVENTION

1. Field of the Invention

This invention relates to a mounting head rod for a roll-up window blind and particularly for a sideway slidable roll-up window blind. The length of the rod is adjustable for mounting the window blind in window openings of various widths.

2. Background Art

A sideway slidable window blind generally consists of two window blind panels mounted side by side on a head rod of a fixed length which is equal to the length of the inside length of an adjustable external housing. The length of the housing is variable for mounting it inside the width of window frames of various widths. Commonly, the panels are mounted to the head rod with two slidable rods. The window blind panels are slidably adjustable sideway to provide selected manners of covering of the window.

A mounting housing for a new type of sideway slidable roll-up window blind is shown in U.S. Pat. No. 7,621,313 issued on Nov. 24, 2009 to the inventor of the present application. In such new type of sideway slidable roll-up window blind, two blind panels are mounted on a composite head rod having two tubular rods telescopically mounted to one another. The panels are slidable sideway in aligned bottom slots formed in the two tubular rods, so that the panels may be pulled sideway relative to one another to provide a selected amount of covering for the window. However, the inclusion of external adjustable housing renders the mounting relatively complex and cumbersome to handle.

### SUMMARY OF THE INVENTION

It is a principal object of the present invention to provide an adjustable head rod without external housing for a sideway adjustable roll-up window blind.

It is another object of the present invention to provide an adjustable head rod having two tubular rods telescopically mounted together to an inner rod which is mounted to the window frame. One panel of the blind is slidable sideway relative to the other panel to provide a selected manner of covering for the window.

It is yet another object of the present invention to provide a head rod for a sideway adjustable roll-up window blind in which the roll-up mechanism for the blind panels is directly mounted to the rod.

It is another object of the present invention to provide an adjustable head rod for a roll-up window blind in which the blind panels are mounted to two tubular rods slidably mounted to one another and the two tubular rods are, in turn, mounted to a telescopic inner rod adjustable for mounting the head rod to windows of various widths.

It is still another object of the present invention to provide an adjustable head rod for a roll-up window blind, in which the rod has a simple construction and is easy to install to a window frame.

The objects, advantages and other features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a front perspective elevation view of the roll-up window blind having a head rod according to the present invention.

FIG. 2 is an isolated bottom perspective elevation view of the head rod showing the bottom slot formed over its entire length according to the present invention

FIG. 3 is a sectional side elevation view of the adjustable head rod along the section line III-III of FIG. 2.

FIG. 4 is an enlarged cross sectional isolated end view of the head rod along cross sectional line IV-IV of FIG. 1.

FIG. 5 is a front perspective elevation view of a second embodiment of the head rod with the two tubular rods slidably mounted on an inner rod rotatably mountable to the inner side walls of a window.

FIG. 6 is a bottom perspective elevation of the second embodiment of FIG. 1.

FIG. 7 is a cross sectional side elevation view along section line VII-VII of FIG. 6.

FIG. 8 is an enlarged cross sectional isolated end view along section line of FIG. 5.

FIG. 9 is a cross sectional a cross sectional side view along the longitudinal axis of the third embodiment of the head rod according to the present invention having a telescopic inner rod.

FIG. 10 is an enlarged cross sectional isolated end view along section line X-X of FIG. 9.

### DETAILED DESCRIPTION OF THE PREFERRED EMBODIMENTS

With reference to the drawings in which like reference numerals designate same parts in the different views, the head rod 10 of a roll-up blind 11 has a first elongated outer tubular rod 12 of a predetermined fixed length for mounting within a window frame. The outer rod 12 is rotatably mounted to two brackets (not shown) secured to the inner side walls of the window frame. A teethed wheel 13 is mounted at one end of the tubular outer rod 12 such that the rod 12 may be rotatably operated with a pull chain engaged with the wheel 13 in the conventional manner. A slot 14 is formed at the bottom of the tubular outer rod 12. The bottom slot 14 extends throughout the entire length of the outer rod 12. A second rod 15, preferably also tubular in construction, and having an outer diameter slightly smaller than the inside diameter of the outer rod 12 and having a length longer half the length of the outer rod 12. The second rod 15 is slidably mounted within the end portion of the outer rod 12 and located opposite to the teethed wheel 13.

A first window blind panel 16 having an upper end secured to the outer rod 12 and located juxtaposed to the teethed wheel 13. The first window blind panel 16 has a width slightly wider than half the length of the outer rod 12.

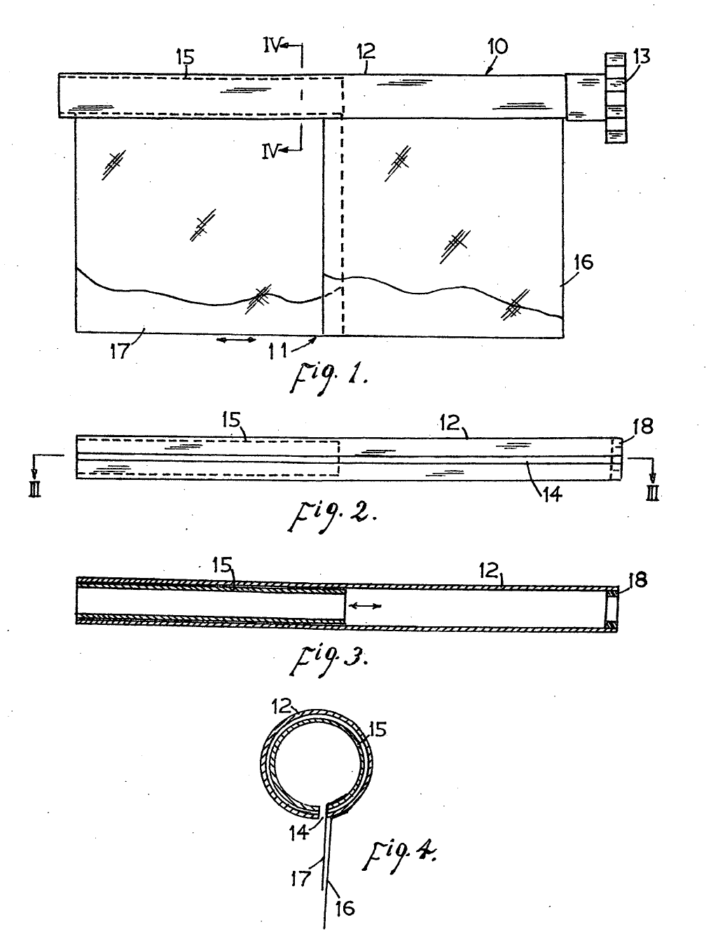

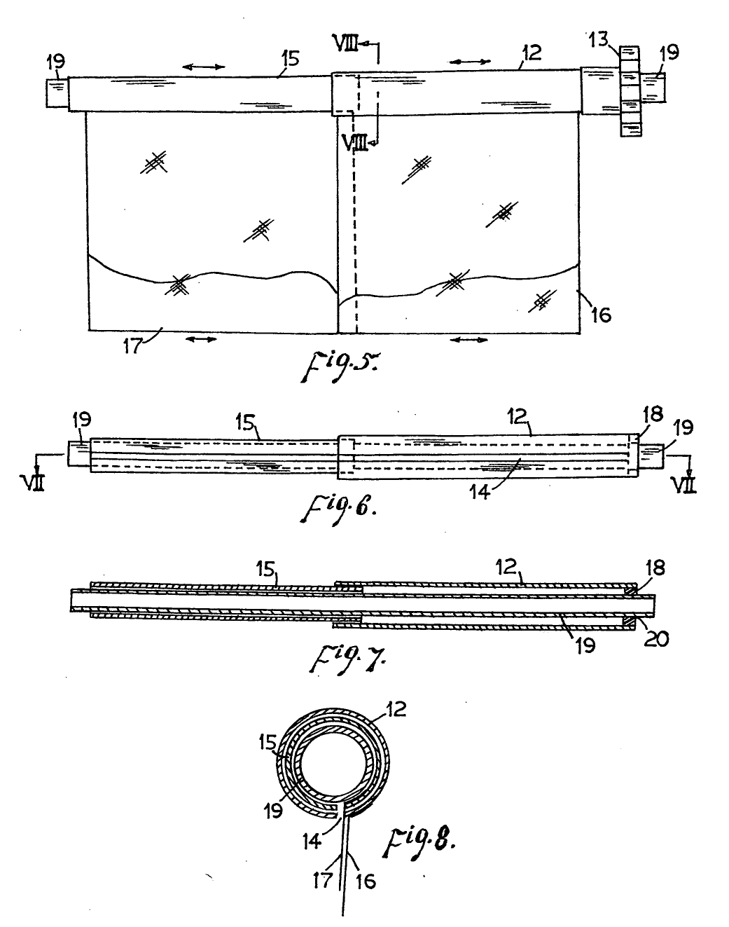

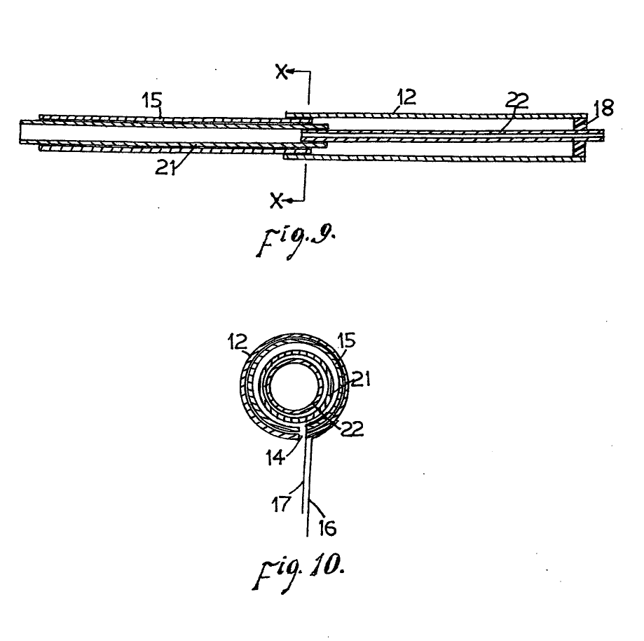

A second window blind panel 17 has an upper end secured to the second rod 15 with the panel extending downward through the bottom slot 14 of the outer rod 12. The first window blind panel 16 and the second window blind panel 17 preferably have inner vertical side edge portions overlapping with one another as best shown in FIG. 1. The second window blind panel 17 is sideway movable relative to the first window blind panel 16 when the two panels are in the fully pulled down extended condition to provide various selected amounts of covering for the window. The second rod 15 is slidable sideway relative to the outer rod 12 in this operation, and the second window blind panel 17 is slidable along the bottom slot 14 of the outer rod 12.

A spacer ring 18 may be mounted in the end portion of the outer rod 12 at the end with the teethed wheel 13 mounted thereon.

A second embodiment of the head rod according to the present invention is best shown in FIG. 5, in which the first tubular rod 12 and the second tubular rod 15 have an equal length slightly longer than half the total length of the entire head rod 10. The bottom slot 14 is formed at the bottom of the first tubular rod 12 and extends throughout its entire length therein. Both the first tubular rod 12 and the second tubular rod 15 are slidably mounted to an elongated inner rod 19. The inner rod 19 has a length equal to the inside width of the window frame in which the head rod 10 is to be rotatably mounted with two mounting brackets (not shown). The teethed wheel 13 is mounted at the end portion of the first tubular rod 12 and located distal to the second tubular rod 15. The upper end of the first window blind panel 16 is secured to the first tubular rod 12, and the upper end of the second window blind panel 17 is secured to the second tubular rod 15. The inner vertical edge portions of the first window blind panel 16 and the second window blind panel 17 overlap with one another. Each one of the two window blind panels 16 and 17 may be moved sideway relative to one another by pulling the panels to move the respective tubular rods 12 and 15 relative to the inner rod 19 so as to obtain various desirous manners of covering of the window. The teethed wheel 13 is mounted at the end of the first tubular rod 12 and located distal to the second tubular rod 15. Alternatively, the teethed wheel 13 may be mounted on the end portion of the inner rod 19 and located distal to the second tubular rod 15.

The end portion of the inner rod 19 slidably engaged with the opening 20 of the spacer ring 18 for supporting the inner rod 19 in a horizontal position so that the window blind panels 16 and 17 would wind properly onto the head rod 10. The spacer ring 18 may be made of a plastic material.

A third embodiment of the present invention is provided with a telescopic inner tube 19 consisting of two tubular rods 21 and 22 telescopically and slidably mounted to one another. The telescopic inner tube 19 is adjustable in a selected length for mounting the head rod 10 in window frames of various widths. The first tubular rod and the second tubular rod have the same construction a in the second embodiment as described above.

It can be appreciated from the above description that the head rod of the present invention has simple construction and can be easily installed in a window frame.

While I have shown and described the preferred embodiments of the present invention, I wish it to be understood that I do not confine myself to the precise details of the exemplary constructions herein set forth by way of illustration, as it is apparent that many changes and variations may be made therein, by those skilled in the art, without departing from the spirit of the invention or exceeding the scope of the appended claims.

What is claimed is:

1. A head rod for a roll-up window blind comprising,
a first tubular rod having a bottom slot opening formed through the entire length therein,
a second tubular rod having an outer diameter smaller than an inner diameter of said first tubular rod and being slidably mounted within an end portion of said first tubular rod,
a teethed wheel mounted at an end portion of said first tubular rod and located distal to said second tubular rod,
a first window blind panel having an upper end secured to said first tubular rod,
a second window blind panel having an upper end secured to said second tubular rod and extending downward through, said bottom slot of said first tubular rod,
said first window blind panel and said second window blind panel having vertical side edges overlapped with one another and said second window panel being movable sideway relative to said first window blind panel to provide selected manners of covering of a window with said head rod rotatably mounted to brackets secured to inner side walls of said window.

2. A head rod according to claim 1 wherein said first tubular rod has a length equal to inner width of said window.

3. A head rod according to claim 2 wherein said first tubular rod has a length equal to said inner width of said window frame, and said second tubular rod has a length longer than half of the length of said first inner rod.

4. A head rod according to claim 3 including an elongated inner rod slidably mounted within said first tubular rod and said second tubular rod, said inner rod having a length equal to the inner width of said window frame.

5. A head rod for a roll-up window blind for mounting within a window frame comprising,
a first tubular rod having an elongated slot formed in a bottom portion therein, said slot extending through the entire length of said first tubular rod,
said first tubular rod having a length longer than half the width of said window frame,
a second tubular rod having an outer diameter smaller than an inner diameter of said first tubular rod and having a length similar to the length of said first tubular rod, said second tubular rod being slidably mounted within an end portion of said first tubular rod,
a first window blind panel having an upper end secured to said first tubular rod,
a second window blind panel having an upper end secured to said second tubular rod and extending downward through said bottom slot of said first tubular panel,
a telescopic inner rod slidably mounted within said first tubular rod and said second tubular rod, and being adjustable in length for mounting said head rod in window frames of various widths.

6. A head rod for a roll-up window blind according to claim 5 wherein said telescopic inner includes two tubular members slidably mounted to one another.

7. A head rod for a roll-up window blind according to claim 6 including a teethed wheel mounted at one end portion of said first tubular rod and located distal to said second tubular rod.

8. A head rod for a roll-up window blind according to claim 6 including a teethed wheel mounted at one end of said inner rod and located distal to said second tubular rod.
